(19) United States
(12) Patent Application Publication
(10) Pub. No.: US 2025/0371246 A1
(43) Pub. Date: Dec. 4, 2025

(54) INFORMATION DISPLAY METHOD AND APPARATUS, ELECTRONIC DEVICE, AND STORAGE MEDIUM

(71) Applicant: Beijing Zitiao Network Technology Co., Ltd., Haidian District (CN)

(72) Inventors: Qi DONG, Beijing (CN); Jiacheng LIU, Beijing (CN); Chang LIU, Beijing (CN); Chengcheng YANG, Beijing (CN)

(21) Appl. No.: 19/225,072

(22) Filed: Jun. 2, 2025

(30) Foreign Application Priority Data
Jun. 3, 2024 (CN) 202410711583.2

(51) Int. Cl. G06F 40/109; G06F 3/0481; G06F 3/0484

(52) U.S. Cl. CPC G06F 40/109; G06F 3/0481; G06F 3/0484

(57) ABSTRACT

An information display method and apparatus, an electronic device, and a storage medium are provided. The method includes: acquiring, in response to detecting that an information display condition is satisfied, first information, where the first information includes a display text and a display timestamp, the display text is associated with a multimedia data stream played by at least one second platform associated with a first platform, or the display text is associated with a multimedia data stream invoked from the first platform; and displaying the display text in a display interface of the first platform, where the display text includes a first subtext and a second subtext, the first subtext is displayed in a different form from the second subtext in the display interface, and the first subtext is a subtext matched with the display timestamp.

### CROSS-REFERENCE TO RELATED APPLICATION

This application claims the priority of Chinese Patent Application No. 202410711583.2 filed on Jun. 3, 2024, and the disclosure of the above-mentioned Chinese Patent Application is hereby incorporated in its entirety by reference as a part of this application.

### TECHNICAL FIELD

Embodiments of the present disclosure relate to the technical field of image processing, and in particular, to an information display method and apparatus, an electronic device, and a storage medium.

### BACKGROUND

With the rapid development of the internet technology, a wide variety of effect props are widely applied in various display scenes.

At present, for normal effect props, effect processing is carried out on a target object in multimedia data such as an image, a video and the like, which lacks of real-time effect display on audio data, and involves the problem of high limitation of the effect application range.

### SUMMARY

The present disclosure provides an information display method and apparatus, an electronic device, and a storage medium, which achieves the technical effect that when an effect prop is produced or an effect is displayed, the effect corresponding to a multimedia data stream can be displayed, thereby improving the general applicability of effect production or usage.

In a first aspect, an embodiment of the present disclosure provides an information display method, including:
acquiring, in response to detecting that an information display condition is satisfied, to-be-displayed target information, where the target information includes a display text and a display timestamp, the display text is associated with a multimedia data stream played by at least one second platform associated with a first platform, or the display text is associated with a multimedia data stream invoked from the first platform; and
displaying the display text in a display interface of the first platform, where the display text includes a first subtext and a second subtext, the first subtext is displayed in a different form from the second subtext in the display interface, and the first subtext is a subtext matched with the display timestamp.

In a second aspect, an embodiment of the present disclosure further provides an information display apparatus, including:
a target information determination module, configured to acquire to-be-displayed target information in response to detecting that an information display condition is satisfied, where the target information includes a display text and a display timestamp, the display text is associated with a multimedia data stream played by at least one second platform associated with a first platform, or the display text is associated with a multimedia data stream invoked from the first platform; and
a target information display module, configured to display the display text in a display interface of the first platform, where the display text includes a first subtext and a second subtext, the first subtext is displayed in a different form from the second subtext in the display interface, and the first subtext is a subtext matched with the display timestamp.

In a third aspect, an embodiment of the present disclosure further provides an electronic device, including:
one or more processors; and
a storage device, configured to store one or more programs,
where the one or more programs, when executed by the one or more processors, cause the one or more processors to implement the information display method according to any one of the embodiments of the present disclosure.

In a fourth aspect, an embodiment of the present disclosure further provides a non-transitory computer-readable storage medium, including computer-executable instructions. The computer-executable instructions, when executed by a computer processor, are configured to cause the computer processor to execute the information display method according to any one of the embodiments of the present disclosure.

### BRIEF DESCRIPTION OF DRAWINGS

In combination with the drawings and referring to the following specific implementations, the above-mentioned and other features, advantages, and aspects of each embodiment of the present disclosure will become more obvious. Throughout the drawings, the same or similar reference signs represent the same or similar elements. It should be understood that the drawings are schematic, and components and elements are not necessarily drawn in scales.

FIG. 1 is a schematic flowchart of an information display method provided by an embodiment of the present disclosure;

FIGS. 2a-2b are schematic diagrams of displaying subtexts in a display interface of a first platform, as involved in an embodiment of the present disclosure;

FIG. 3 is a schematic diagram of a parameter regulation control in a display interface, as involved in an embodiment of the present disclosure;

FIGS. 4a-4c are schematic diagrams of text display regions corresponding to different target region rotation angles, as involved in an embodiment of the present disclosure;

FIG. 5 is a schematic flowchart of another information display method provided by an embodiment of the present disclosure;

FIG. 6 is a schematic diagram of a subtext display entity as involved in an embodiment of the present disclosure;

FIG. 7 is a schematic flowchart of yet another information display method provided by an embodiment of the present disclosure;

FIGS. 8a-8b are schematic diagrams of a subtext display effect in a distinguishing display entity, as involved in an embodiment of the present disclosure;

FIG. 9 is a schematic structural diagram of an information display apparatus provided by an embodiment of the present disclosure; and

FIG. 10 is a schematic structural diagram of an electronic device provided by an embodiment of the present disclosure.

### DETAILED DESCRIPTION

The embodiments of the present disclosure will be described in more detail with reference to the accompanying drawings hereinafter. Although certain embodiments of the present disclosure are shown in the accompanying drawings, it should be understood that the present disclosure can be implemented in various forms and should not be construed as being limited to the embodiments set forth herein. On the contrary, these embodiments are provided for a more thorough and complete understanding of the present disclosure. It should be understood that the accompanying drawings and embodiments of the present disclosure are only for exemplary purposes and are not intended to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including/comprising” and its variants are open-ended inclusions, that is, “including/comprising but not limited to”. The term “based on” is “at least partially based on”. The term “an/one embodiment” means “at least one embodiment”; the term “another embodiment” means “at least one other embodiment”; the term “some embodiments” means “at least some embodiments”. Related definitions of other terms will be given in the following description.

It should be noted that the concepts of “first” and “second” mentioned in the present disclosure are only used to distinguish different apparatuses, devices, modules or units, and are not used to limit the order or interdependence of the functions performed by these apparatuses, devices, modules or units.

It should be noted that the modifiers of “a” and “a plurality” mentioned in the present disclosure are illustrative rather than limitative, and those skilled in the art should understand that unless the context clearly indicates otherwise, they should be understood as “one or more”.

Names of messages or information exchanged among multiple devices in the embodiments of the present disclosure are only used for illustrative purposes, and are not used to limit the scope of these messages or information.

It can be understood that before using the technical solutions disclosed in various embodiments of the present disclosure, users should be informed of the types, scope of usage, usage scenarios, etc. of personal information involved in the present disclosure in an appropriate way according to relevant laws and regulations, and authorizations from users should be acquired.

For example, in response to receiving the user's active request, prompt information is sent to the user to clearly remind the user that the operation requested by the user will require obtaining and using the user's personal information. Therefore, the user can independently choose whether to provide personal information to software or hardware such as electronic devices, applications, servers or storage medium that perform the operation of the technical solutions of the present disclosure according to the prompt information.

As an optional but non-limiting implementation, in response to receiving the user's active request, the way to send the prompt information to the user can be, for example, a pop-up window, in which the prompt information can be presented in text. In addition, the pop-up window can also carry a selection control for the user to choose “agree” or “disagree” to provide personal information to the electronic device.

It can be understood that the above process of notifying and obtaining user authorization is only schematic, and does not limit the implementation of the present disclosure. Other ways to meet relevant laws and regulations can also be applied to the implementation of the present disclosure.

It can be understood that the data involved in the technical solutions (including but not limited to the data itself, data acquisition or usage) shall comply with the requirements of corresponding laws, regulations and relevant regulations.

Prior to the explanation of the present technical solution, an application scene will be exemplarily described first. The present technical solution may be applied in a scene where an effect prop is produced and/or a scene where effect display is performed based on the produced effect prop.

In the scene where the effect prop is produced, when the effect prop is produced in an effect production platform, an effect prop kit may be produced by adopting the method provided by this embodiment. Exemplarily, a platform with an effect production function is a first platform, and the first platform further includes other modules or components with an audio playback function. When the effect prop kit is produced in the first platform, firstly, target information of a multimedia data stream (explanation is given with reference to the case where the multimedia data stream is a music song, by way of example) of the first platform, which is being played, may be invoked, the target information may be a lyric, a singer name, a music name and the like, and the target information may be displayed in a display page of the first platform; meanwhile, music segments played at different moments in the first platform may also be acquired in real time, and distinguishing display is carried out on different text content in the target information according to timestamps corresponding to the music segments, for example, if a music segment corresponding to a T1 moment is played currently, the lyric corresponding to the music segment at the T1 moment can be displayed in bold and enlarged size; and finally, synchronous display information in a playback process of the music may be packaged into an effect prop kit.

In the scene where effect display is performed based on the produced effect prop, after the effect prop kit produced in advance is loaded into an effect panel in a target application, when a user performs a triggering operation on the effect prop kit, effect display may be carried out according to the method provided by this embodiment. Exemplarily, a platform for bearing the effect prop kit is the first platform; and other platforms that are in communicative connection with the first platform and have the audio playback function are the second platforms. When the user triggers the effect prop kit produced in advance in an effect panel of the first platform, target information of a multimedia data stream (explanation is given with reference to the case where the multimedia data stream is a music song, by way of example) of a second platform, which is being played, may be acquired and displayed, and the specific display process may refer to the previous example and will not be repeated herein.

It should be noted that the target information may also be referred to as first information, and the two terms are used interchangeably in the present disclosure.

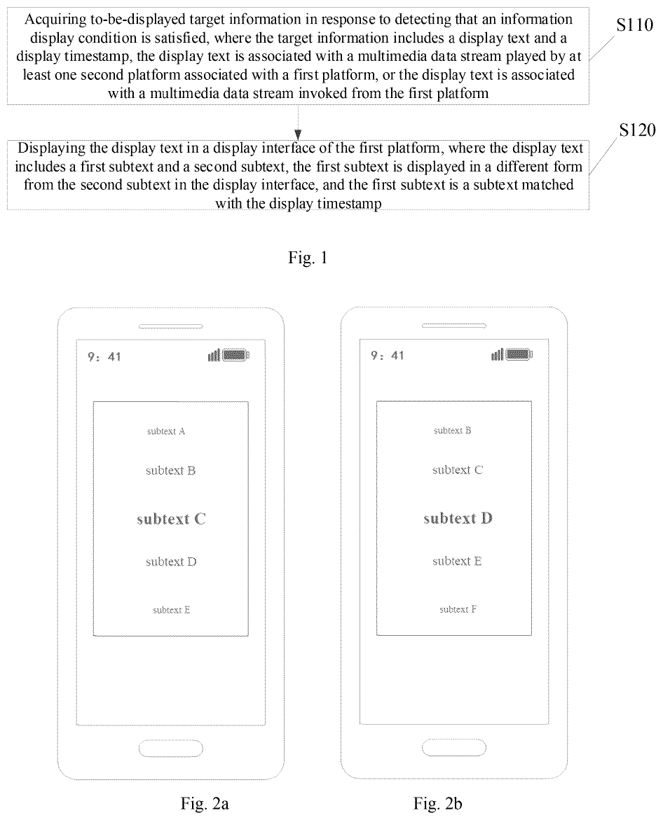

FIG. 1 is a schematic flowchart of an information display method provided by an embodiment of the present disclosure. The embodiment of the present disclosure is applicable to a random scene where an effect prop needs to be produced and/or a scene where effect display is performed based on the produced effect prop. The method may be executed by an information display apparatus, the apparatus may be implemented in the form of software and/or hardware and optionally, is implemented by an electronic device, and the electronic device may be a mobile terminal, a PC terminal or a server and the like

As shown in FIG. 1, the method provided by this embodiment, for example, may include:
S110: acquiring, in response to detecting that an information display condition is satisfied, to-be-displayed target information, where the target information includes a display text and a display timestamp, the display text is associated with a multimedia data stream played by at least one second platform associated with a first platform, and/or the display text is associated with a multimedia data stream invoked from the first platform.

For example, the first platform is a client, a network page or the like, which has an effect prop production function and/or application and displays an effect prop kit. The first platform may include other modules or components which have an audio playback function or can invoke and play an audio. The second platforms are other platforms which are in communicative connection with the first platform and have the audio playback function, and are clients or network pages and the like.

For example, the multimedia data stream may be a data stream formed by at least one type of audio media. Exemplarily, the multimedia data stream may include a music, an audio recording, local audio and video, and/or online audio and video, which are being played. The music may be a played music; the audio recording may be an audio which is customized and recorded by a user; and the audio and video may be media data including an audio and a video image. It could be understood that in a live streaming scene, the multimedia data stream may also be a live streaming image and audio information simultaneously presented in a live streaming page, i.e., the online audio-video.

For example, the target information includes displayable information corresponding to multimedia data. The displayable information may be a display text, a display sticker and the like. The display text is text information corresponding to the multimedia data stream, and the display text may include a plurality of subtexts. For example, in a case that the multimedia data stream is a music song, the display text may include text information such as a music name, a singer name, a release date, a lyric and the like, and each sentence in the lyric may be regarded as one subtext; and in a case that the multimedia data stream is an audio recording, the display text may include a specific recording time, a name and subtitles of the audio recording, and each sentence in the subtitles may be regarded as one subtext. In addition to this, the target information further includes data content associated with the multimedia data. For example, the target information may include: an identification code of each multimedia data stream among all the multimedia data streams; a start timestamp and an end timestamp of each subtext in a certain multimedia data stream, i.e., a display timestamp; and the like. For example, the display timestamp is a playback timestamp corresponding to a data stream which has been completely played at a current moment, relative to a reference start moment of the multimedia data stream.

For example, the information display condition is a triggering condition for determining when the target information is acquired. In this embodiment, the information display condition includes at least one of the followings: triggering an effect prop corresponding to the displayed target information; and detecting an operation of switching the displayed target information. For the first type of information display condition, the effect prop may be triggered by a control displayed on a display interface of an application software, and triggering of the control represents that the target information needs to be displayed. In the actual application, a control capable of triggering a selected effect prop may be configured in advance in the display interface of the application software, if a user triggers the control, it may be considered that a function of displaying the target information is to be triggered, and at the moment, the to-be-displayed target information can be acquired. For the second type of information display condition, an operation capable of triggering switching on display information may be pre-defined in the display interface of the application software, and in a case that there has been original target information (the original target information corresponds to an original multimedia data stream) which is being displayed, when the user triggers a control of switching the display information, new target information (the new target information corresponds to a multimedia data stream to be switched to) may be acquired, and the new target information is the to-be-displayed target information. Exemplarily, a leftward sliding or rightward sliding operation may be defined at a specific position in the display interface, when the user triggers the leftward sliding or rightward sliding operation, the original multimedia data stream is switched to other multimedia data streams different from the original multimedia data stream, and at the moment, new target information corresponding to other multimedia data streams is the to-be-displayed target information. In addition to this, it's also possible that, when the user triggers, from a multimedia selection page, an operation of selecting other multimedia data streams different from the original multimedia data stream, new target information corresponding to other multimedia data streams is the to-be-displayed target information.

Exemplarily, in the scene where the effect prop is produced, when the user produces the effect prop in the first platform and any one type of information display condition mentioned above is satisfied, for example, when the user triggers a control of “starting to produce a prop”, if the second platform that is in communicative connection with the first platform is playing a multimedia data stream, target information corresponding to the multimedia data stream may be acquired from the second platform; and if an audio playback function module in the first platform is playing a multimedia data stream, target information corresponding to the multimedia data stream may be acquired from the audio playback function module.

Exemplarily, in the process of playing a target music based on a music playback plug-in in the first platform, the user triggers the effect prop corresponding to the displayed target information in the first platform; at this moment, text information of a music name, a singer name, a lyric or the like corresponding to the target music, and a display timestamp in the playback process of the target music may be acquired from the music playback plug-in, and this information is the to-be-displayed target information.
S120: displaying the display text in a display interface of the first platform, where the display text includes a first subtext and a second subtext, the first subtext is displayed in a different form from the second subtext in the display interface, and the first subtext is a subtext matched with the display timestamp.

For example, the display text is formed by a plurality of subtexts. For example, in a case that the display text is the lyric, the subtext may be each sentence in the lyric; and in a case that the multimedia data stream is an audio recording, the subtext may be each sentence in the subtitles of the audio recording. A text display region may be configured in advance in the display interface of the first platform, and the text display region is a specific region for displaying the display text. For example, the text display region may be a display region with an adjustable size, position, and shape. The display text includes one first subtext and at least one second subtext, and the first subtext is a subtext matched with the display timestamp. The second subtext is different from the first subtext.

In this embodiment, in the process of playing the multimedia data stream, the display timestamp is a time-varying quantity. For example, the total duration of a music being played currently is 2 minutes, the 0^{th} second of the music is the reference start moment, and in the process of playing the music, the display timestamp is sequentially changed into: 0 minute 0 second, 0 minute 1 second, 0 minute 2 seconds, . . . , 2 minutes 0 second.

Exemplarily, the display text may be dynamically displayed in the display interface of the first platform. That is, it could be understood that in the process of playing the multimedia data stream, with the passage of time, in a case that a pause control is not triggered, the display timestamp is changed constantly. Content of the data stream being played at the current moment is also changed, and there are different correspondence relationships between the display timestamp and various subtexts in the display text. In order to highlight the content of the data stream being played at the current moment, on the basis of determining the display timestamp, a target subtext corresponding to the display timestamp is the first subtext. Based on this, a text font, a text color, a text size and the like of the first subtext may be distinguished from those of the other subtexts (i.e., the second subtexts) so as to achieve the purpose of distinguishing display of the target subtext. Meanwhile, distinguishing display may also be achieved among the second subtexts. For example, for the data stream having been played or the data stream having not been played, the longer the time interval between the start timestamp and the display timestamp is, the smaller the font and also the higher the transparency of the corresponding second subtext will be; and the shorter the time interval between the start timestamp and the display timestamp is, the larger the font and also the lower the transparency of the corresponding second subtext will be.

Exemplarily, schematic diagrams of the subtexts displayed in the display interface of the first platform refer to FIGS. 2a-2b. As shown in FIG. 2a, the display text includes 5 subtexts which respectively are a subtext A, a subtext B, a subtext C, a subtext D, and a subtext E. If a playback time range corresponding to the subtext A is 0 minute 10 seconds to 0 minute 30 seconds, a playback time range corresponding to the subtext B is 0 minute 40 seconds to 0 minute 55 seconds, a playback time range corresponding to the subtext C is 1 minute 10 seconds to 1 minute 30 seconds, and a playback time range corresponding to the subtext D is 1 minute 35 seconds to 1 minute 58 seconds, in a case that the display timestamp corresponding to the current moment is 1 minute 15 seconds, it is easy to determine that the display timestamp is positioned in the playback time range corresponding to the subtext C; correspondingly, the subtext C may be the first subtext, while the subtext A, the subtext B, the subtext D, and the subtext E are the second subtexts. An amplification processing may be carried out on the “subtext C”, fonts of the subtext A and the subtext E may be set to be the smallest, and fonts of the subtext B and the subtext D may be set to be the second smallest, so as to achieve the purpose of distinguishing display of different subtexts. Subsequently, with the passage of time, when the display timestamp is positioned in the playback time range corresponding to the subtext D, a schematic diagram illustrating display effects of various subtexts refers to FIG. 2b; in such case, all the subtexts are moved upwards integrally, and an amplification processing is carried out on the text of the subtext D, fonts of the subtext B and a subtext F are set to be the smallest, and fonts of the subtext C and the subtext E are set to be the second smallest, so as to achieve real-time effect display of the audio content.

Based on the embodiment above, the method further includes: displaying at least one parameter regulation control in the display interface; and in response to a triggering operation on the at least one parameter regulation control, determining a region display parameter for displaying the display text in the display interface and a text display parameter of the display text in the text display region.

For example, the parameter regulation control is a preset control for regulating a display parameter in the display interface. The parameter regulation control is represented in the form of a progress bar, and different positions in the progress bar correspond to different parameter values. There may be one or more parameter regulation controls.

In this embodiment, the region display parameter includes at least one selected from the group consisted of a region transparency parameter, a border display color parameter, a region rotation angle regulation parameter, a region size regulation parameter, and a region display position parameter. For example, the region transparency parameter is configured to represent the degree of transparency of the text display region; the border display color parameter is configured to represent a display color of a border of the text display region; the region size regulation parameter may represent a size of the text display region; and the region display position parameter is configured to represent a specific position of the text display region in the display interface, and a specific representation of the region display position parameter may be position coordinates corresponding to a central point of the text display region. The text display parameter includes at least one selected from the group consisted of a font color parameter, a font type parameter, a font transparency parameter, and a font inclination angle parameter. For example, the font color parameter is configured to represent a display color of the display text; the font type parameter is configured to represent a font type of the display text, and for example, the font type may be the Song typeface, the regular script and the like; the font transparency parameter is configured to represent the degree of transparency of the display text; and the font inclination angle parameter is configured to represent an inclination degree of the display text. According to this embodiment, by regulating the multidimensional parameters corresponding to the text display region and the display text, the purpose of customized setting of the display content is achieved, and richness of the display content is improved.

Exemplarily, at least one parameter regulation control may be displayed at the same time when the text display region is displayed in the display interface; alternatively, at least one parameter regulation control may be displayed when the user triggers a parameter regulation pull-down control. When the user slides a target control of any one parameter regulation control on the progress bar, a specific parameter value corresponding to the position of the target control at a moment when the sliding stops is used as a target display parameter; if the parameter regulation control is a regulation control corresponding to the region display parameter, the target display parameter is the region display parameter of the text display region; and if the parameter regulation control is operated by a regulation control corresponding to the text display parameter, the target display parameter is the text display parameter of the display text in the text display region. The purpose of such settings is that the user, by using the parameter regulation controls, may carry out customized regulation on the display content according to user demands, so that interaction between the user and the display page is improved, and personalized demands of the user are satisfied.

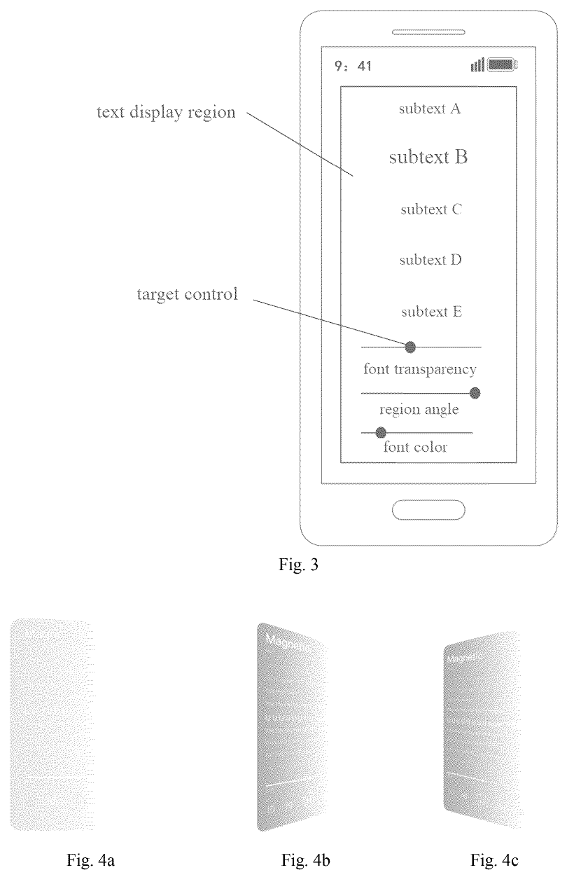

Exemplarily, a schematic diagram illustrating the parameter regulation controls in the display interface refers to FIG. 3. As shown in FIG. 3, a large rectangular frame in the display interface is the text display region, three black solid lines (the black solid lines represent the progress bars) below the display interface are three parameter regulation controls, and black dots in the progress bars are the target controls, in which a first progress bar represents the parameter regulation control corresponding to the font color parameter (the font transparency), a second progress bar represents the parameter regulation control corresponding to the region rotation angle regulation parameter (the region rotation angle), and a third progress bar represents the parameter regulation control corresponding to the font color parameter (the font color).

It should be particularly noted that the parameter regulation operations described above may be carried out, in advance, before the effect prop kit is produced, or may be carried out in the process of displaying the effect prop kit.

Based on the embodiment above, optionally, the method further includes: in the process of displaying the display text, in response to detecting that a region rotation angle regulation control in the parameter regulation control is triggered, determining a regulated target region rotation angle; and determining a transparency value corresponding to each pixel point in the text display region according to the target region rotation angle, so as to display the text display region based on the transparency value.

Exemplarily, a correspondence relationship between the region rotation angle and the transparency value of each pixel point may be determined in advance; in the specific application, when the user slides the target control on the progress bar corresponding to the region rotation angle regulation control, an angle value corresponding to the position of the target control at a moment when the user stops sliding is the target region rotation angle, so that the transparency value of each pixel point corresponding to the target region rotation angle can be determined according to the correspondence relationship. In this way, the text display region can be displayed according to the transparency value corresponding to each pixel point. In this embodiment, based on the target region rotation angle, the corresponding transparency value is determined, so that brightness and darkness variations of the text display region at different angles can be achieved, and a dynamic effect of rotation of the text display region is presented.

Exemplarily, schematic diagrams illustrating text display regions corresponding to different target region rotation angles refer to FIGS. 4a-4c. As shown in FIG. 4a, when the target region rotation angle is 0 degree, the transparency values of the pixel points of the text display region, from left to right, are sequentially increased, and the maximum transparency value at the right side of the text display region is 90%. As shown in FIG. 4b, in a case that the text display region rotates leftwards, the maximum value of the target region rotation angle is 90 degrees, the minimum transparency value at the right side of the text display region is 70%; as the target region rotation angle is changed within a range of 0 degree to 90 degrees, the transparency at the right side of the region is changed within a range of 70% to 90%, and the transparency values of other pixel points in the text display region are changed with the change at the right side of the region. As shown in FIG. 4c, in a case that the text display region rotates rightwards, the maximum value of the target region rotation angle is 90 degrees, the minimum transparency value at the right side of the text display region is 70%; as the target region rotation angle is changed within a range of 0 degree to 90 degrees, the transparency at the right side of the region is changed within a range of 70% to 90%, and the transparency values of other pixel points in the text display region dynamically change based on the vignetting levels.

According to the technical solution of the embodiment of the present disclosure, when it is detected that the information display condition is satisfied, the to-be-displayed target information is acquired, where the target information includes the display text and the display timestamp, the display text is associated with the multimedia data stream played by at least one second platform associated with the first platform, or the display text is associated with the multimedia data stream invoked from the first platform; and the display text is displayed in the display interface of the first platform, where the display text includes the first subtext and the second subtext, the first subtext is displayed in a different form from the second subtext in the display interface, and the first subtext is the subtext matched with the display timestamp. According to the technical solution of the embodiment of the present disclosure, when the effect prop is produced and effect display is performed, the effect corresponding to the multimedia data stream can be displayed, so that general applicability of effect production or usage is improved.

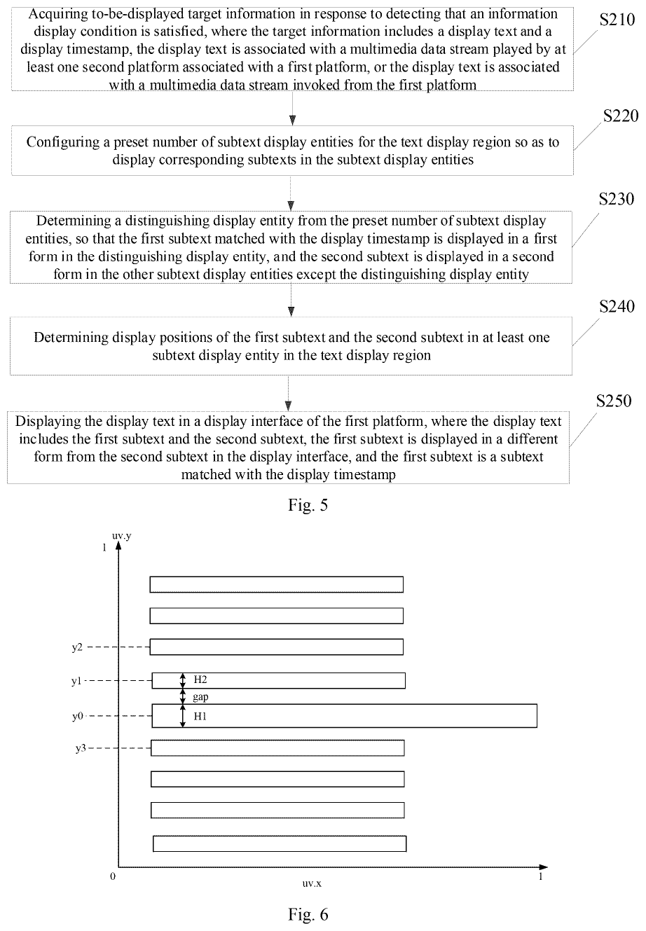

FIG. 5 is a schematic flowchart of another information display method provided by an embodiment of the present disclosure. According to the technical solution of this embodiment, based on the above-described embodiment, before the display text is displayed in the text display region of the display interface, a preset number of subtext display entities may be further configured for the text display region to display the corresponding subtexts in the subtext display entities, and then a distinguishing display entity may be determined, so that the first subtext matched with the display timestamp is displayed in a first form in the distinguishing display entity, and the second subtext is displayed in a second form in other subtext display entities except the distinguishing display entity. In addition to this, display positions of the first subtext and the second subtext in at least one subtext display entity in the text display region may also be determined, and the specific implementation thereof may refer to the detailed illustration of the embodiment of the present disclosure, in which the same or similar technical features with that of the above-described embodiment will not be repeated herein.

As shown in FIG. 5, the method according to this embodiment, for example, may include:
S210: acquiring, in response to detecting that an information display condition is satisfied, to-be-displayed target information, where the target information includes a display text and a display timestamp, the display text is associated with a multimedia data stream played by at least one second platform associated with a first platform, or the display text is associated with a multimedia data stream invoked from the first platform.
S220: configuring a preset number of subtext display entities for the text display region so as to display corresponding subtexts in the subtext display entities.

For example, the subtext display entity is a specific region for bearing the subtext, and for example, the subtext display entity is a rectangular display frame with a certain size.

In this embodiment, a certain number of subtext display entities may be configured in the text display region, for example, the preset number is 9, i.e., 9 subtext display entities may be configured in the text display region, so that in the process of playing the multimedia data stream, different subtexts may be dynamically displayed in different subtext display entities.
S230: determining a distinguishing display entity from the preset number of subtext display entities, so that the first subtext matched with the display timestamp is displayed in a first form in the distinguishing display entity, and the second subtext is displayed in a second form in other subtext display entities except the distinguishing display entity.

For example, the distinguishing display entity is a display entity different from the other subtext display entities, and for example, a size of the distinguishing display entity is greater than those of the other subtext display entities. The first form is different from the second form, and for example, font sizes of the first form and the second form are different.

Exemplarily, on the basis of determining the distinguishing display entity, the first subtext corresponding to the data stream which is being played at the current moment, i.e., the first subtext corresponding to the display timestamp, is distinguishingly displayed in the first form in the distinguishing display entity, and the second text is displayed in the second form in other subtext display entities except the distinguishing display entity, so that the subtext corresponding to the data stream which is being played at the current moment can be prominently displayed, and the user can rapidly view the subtext corresponding to the current playback moment, thereby improving the usage experience of the user. In this embodiment, by determining the subtext display entities and further determining the specific positions of a plurality of subtexts in a display page, the plurality of subtexts may be displayed clearly and orderly, which has good viewing effects based on viewing angels.

Exemplarily, a schematic diagram of the subtext display entity refers to FIG. 6. In FIG. 6, each rectangular strip represents one subtext display entity, i.e., there are 9 subtext display entities in total, in which the subtext display entity positioned at the vertical center position is the distinguishing display entity, and the size of the distinguishing display entity is greater than those of the other subtext display entities.

Based on the above-described embodiment, optionally, the method further includes: determining display positions of the preset number of subtext display entities in the text display region according to first height information of the distinguishing display entity, second height information of other subtext display entities except the distinguishing display entity, and spacing information between two adjacent subtext display entities.

In this embodiment, referring to FIG. 6, H1 represents the first height information of the distinguishing display entity, H2 represents the second height information, and gap represents the spacing information between two adjacent subtext display entities. y0 represents a longitudinal coordinate of the distinguishing display entity, and if the distinguishing display entity is positioned at the central position of the text display region, on the basis that the size of the text display region is a known quantity, the specific value of y0 can be determined. Then, longitudinal coordinates corresponding to all the other subtext display entities except the distinguishing display entity can be calculated one by one in both upward and downward directions, by taking the distinguishing display entity as the center, according to H1, gap, and H2. For example, y1=y0+(H1+H2)/2+gap, y2=y1+H2+gap, y3=y0−(H1+H2)/2−gap; based on the same determination mode, the longitudinal coordinate of each subtext display entity can be determined, i.e., the display position of each subtext display entity in the text display region can be determined. In this way, the display position of each subtext display entity can be efficiently and clearly positioned.
S240: determining display positions of the first subtext and the second subtext in at least one subtext display entity in the text display region.

In this embodiment, there is the case that the number of the subtext display entities is smaller than the total number of the subtexts, thus the first subtext and the second subtext in this step refer to part of subtexts in the display text; for example, they may be the subtexts whose playback time ranges fall within a neighboring time range of the display timestamp. Each subtext is of a different size, and correspondingly, each subtext also has a different display position in the subtext display entity; furthermore, with the playback of the multimedia data stream, the first subtext and the second subtext also change dynamically. In view of this, the display positions, in the subtext display entities, of the first subtext and the second subtext in the text display region need to be determined.

Optionally, an exemplary implementation of determining the display position of at least one subtext in at least one subtext display entity in the text display region may include: for a subtext in the display text, determining scaling information of the subtext according to a text size of the subtext and a region size of the text display region, so as to determine a display scale of the subtext in the text display region based on the scaling information; determining an offset corresponding to the subtext according to the text size of the subtext, an anchor point location, and a preset text alignment; and determining a display position of the subtext in the subtext display entity in the text display region according to the display scale of the subtext, the anchor point location, and the offset.

For example, the text size of the subtext is an original actual size of the subtext. The region size of the text display region is a determined quantity which is easy to obtain. The preset text alignment may include a text alignment of centered alignment or left alignment. The anchor point location may be preset for each subtext display entity. It should be particularly noted that for the same subtext display entity, different alignments correspond to different anchor point locations.

In this embodiment, the way of determining the display position of the subtext in the subtext display entity is the same for all of the at least one subtext, and any one of them is taken as an example for exemplary illustration here. For example, an amplification scale may be determined by amplifying the text size into the region size, and the amplification scale is the scaling information of the subtext. According to the scaling information, a display scale for displaying the subtext in the text display region may be determined.

Further, the text size of the subtext includes width information (textRect.w) and height information (textRect.h); the anchor point location may be represented as (anchorP.x, anchorP.y); in a case that the preset text alignment is the centered alignment, the offset corresponding to the subtext may be represented as: translateOffset=vec2 (anchorP.x, anchorP.y); in a case that the preset text alignment is the left alignment, the offset corresponding to the subtext may be represented as: translateOffset=vec2 (anchorPos.x−textRect.w/2.0, anchorPos.y−textRect.h/2.0); since the default coordinates corresponding to the subtext are (0, 0), after a scaling processing is carried out on the subtext based on the display scale, the subtext is translated according to the offset until the top left corner of the subtext is aligned with the anchor point location, so that the display position of the subtext in the subtext display entity in the text display region can be determined. In this way, the subtext can be adaptively displayed in the subtext display entity, which has an excellent visual effect.
S250: displaying the display text in a display interface of the first platform, where the display text includes the first subtext and the second subtext, the first subtext is displayed in a different form from the second subtext in the display interface, and the first subtext is a subtext matched with the display timestamp.

According to the technical solution of the embodiments of the present disclosure, before the display text is displayed in the text display region of the display interface, a preset number of subtext display entities may also be configured for the text display region so as to display the corresponding subtexts in the subtext display entities; then a distinguishing display entity is determined so as to distinguishingly display the subtext corresponding to the display timestamp in the distinguishing display entity; and by determining the distinguishing display entity, the first subtext matched with the display timestamp is displayed in the first form in the distinguishing display entity, and the second subtext is displayed in the second form in other subtext display entities except the distinguishing display entity. In addition to this, the display positions of the first subtext and the second subtext in at least one subtext display entity in the text display region may also be determined, so that the subtext is adaptively displayed in the subtext display entity, thereby improving the visual effect of the user.

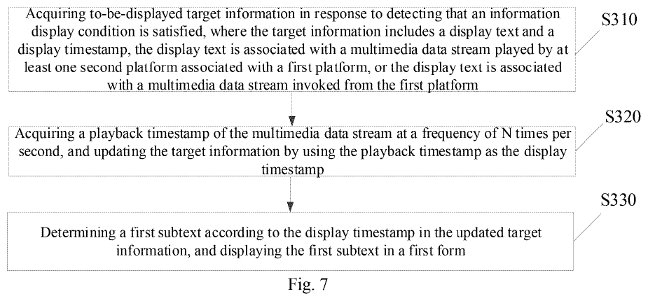

FIG. 7 is a schematic flowchart of yet another information display method provided by an embodiment of the present disclosure. The technical solution of this embodiment, based on the above-described embodiment, illustrates how to display the display text in the display interface of the first platform in detail, and a specific implementation thereof may refer to the detailed illustration of the embodiment of the present disclosure, in which the same or similar technical features with that of the above-described embodiment will not be repeated herein.

As shown in FIG. 7, the method according to this embodiment, for example may include:
S310: acquiring, in response to detecting that an information display condition is satisfied, to-be-displayed target information, where the target information includes a display text and a display timestamp, the display text is associated with a multimedia data stream played by at least one second platform associated with a first platform, or the display text is associated with a multimedia data stream invoked from the first platform.
S320: acquiring a playback timestamp of the multimedia data stream at a frequency of N times per second, and updating the target information by using the playback timestamp as the display timestamp.

N represents an adjustable preset value, for example, the value of N is 15. The playback timestamp is a timestamp corresponding to a multimedia data stream segment which is being played currently.

In the actual application, in the process of playing a multimedia video stream, a pause operation may exist. Since the display timestamp is not necessarily a time span of the multimedia video stream from a playback start moment to the current moment, a playback timestamp when other players play the multimedia data stream may be acquired at a preset frequency, and this playback timestamp is used as the display timestamp. With the passage of time, the display timestamp determined each time is changed constantly, so that the target information may be updated according to the changed display timestamp. For example, a target subtext corresponding to a previous display timestamp is different from that determined at the current moment, i.e., the subtext displayed in the distinguishing display entity needs to be updated, and corresponding updates of changes also need to be carried out on the other subtexts.

In addition to this, there is still a case that the user switches into other multimedia data streams. In such case, all the information content in the target information needs to be updated.
S330: determining a first subtext according to the display timestamp in the updated target information, and displaying the first subtext in a first form.

In this embodiment, since the updated display timestamp is changed, the subtext corresponding to the display timestamp also will be changed. Based on this, the first subtext corresponding to the updated display timestamp needs to be determined according to the updated display timestamp, and the latest determined first subtext and the other second subtexts are differently displayed. Therefore, by updating the display timestamp in real time, the latest target information may be determined so as to realize synchronous updating of the playback process of the multimedia data stream and dynamic display of the subtext.

Based on the above-described embodiment, in a case that the text display region includes the distinguishing display entity, optionally, distinguishingly displaying the corresponding subtext according to the display timestamp in the target information may further include: displaying the first subtext corresponding to the display timestamp in the first form in the distinguishing display entity in the text display region.

For example, the first form includes at least one selected from the group consisted of a playback animation, a display color, and a display font of the first subtext.

For example, the first form refers to that the subtext in the distinguishing display entity is displayed with a distinguishing display parameter; for example, the distinguishing display parameter may be, relative to the other subtexts, a different playback animation, a larger text, a different color, highlight, a different font and the like.

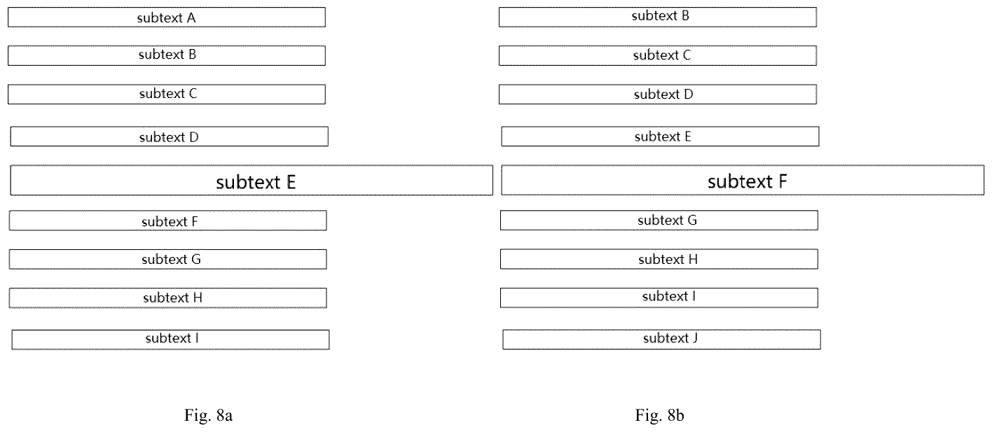

In this embodiment, a schematic diagram of a display effect of the first subtext in the distinguishing display entity refers to FIG. 8a. If the subtext corresponding to the display timestamp is the “subtext E”, the “subtext E” is displayed in the distinguishing display entity with a larger font. Therefore, the subtext corresponding to the data stream which is being played at the current moment may be further prominently displayed, and the user may rapidly view the subtext corresponding to the current playback moment, so that the usage experience of the user is improved.

Further, based on the above-described embodiment, the method further includes: if the display timestamp in the target information is changed, rolling all subtexts corresponding to a previous display timestamp in a first direction, so that the subtext displayed, at the previous display timestamp, in the distinguishing display entity is rolled into the subtext display entity which is adjacent to the distinguishing display entity and is positioned above the distinguishing display entity, and the subtext displayed, at the previous display timestamp, in the subtext display entity which is adjacent to the distinguishing display entity and is positioned below the distinguishing display entity is displayed in the distinguishing display entity in the first form.

Based on the above-mentioned example, referring to FIG. 8b, when the display timestamp is T1, the subtext in the distinguishing display entity is the “subtext E”; in a case that the display timestamp is updated to T2 from TI, the target subtext corresponding to T2 is the “subtext E”; at this moment, all the subtexts may be rolled upwards, the subtext in the distinguishing display entity is the “subtext F”, and amplification display is carried out on the “subtext F” (i.e., the “subtext F” is displayed in a target mode in the distinguishing display entity). In this way, with the change of the display timestamp, the target subtext in the distinguishing display entity is also dynamically changed so as to ensure the real-time performance of prominent display of the subtext corresponding to the audio content which is being played currently.

According to the technical solution of the embodiment of the present disclosure, an exemplary implementation of distinguishingly displaying the corresponding subtext according to the display timestamp in the target information includes: acquiring a playback timestamp when other players play the multimedia data stream at a frequency of N times per second, and updating the target information by using the playback timestamp as the display timestamp; and determining the first subtext according to the display timestamp in the updated target information, and displaying the first subtext in the first form. By updating the display timestamp in real time, the latest target information may be determined so as to implement synchronous updating of the playback process of the multimedia data stream and dynamic display of the subtext, and to ensure real-time performance of prominent display of the subtext.

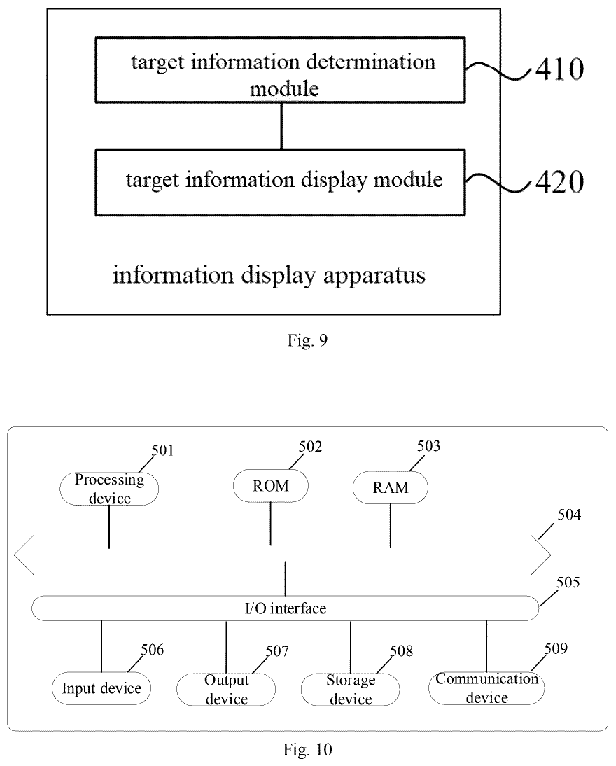

FIG. 9 is a schematic structural diagram of an information display apparatus provided by an embodiment of the present disclosure. As shown in FIG. 9, the apparatus includes: a target information determination module 410 and a target information display module 420.

For example, the target information determination module 410 is configured to: acquire, in response to detecting that an information display condition is satisfied, to-be-displayed target information, where the target information includes a display text and a display timestamp, the display text is associated with a multimedia data stream played by at least one second platform associated with a first platform, the display text is associated with a multimedia data stream invoked from the first platform; and the target information display module 420 is configured to display the display text in a display interface of the first platform, where the display text includes a first subtext and a second subtext, the first subtext is displayed in a different form from the second subtext in the display interface, and the first subtext is a subtext matched with the display timestamp.

Based on each optional technical solution described above, optionally, the information display apparatus further includes: a display parameter regulation module. The display parameter regulation module includes a regulation control display unit and a display parameter regulation unit.

For example, the regulation control display unit is configured to display at least one parameter regulation control in the display interface, where the parameter regulation control is represented in the form of a progress bar; and the display parameter regulation unit is configured to: determine, in response to a triggering operation on the at least one parameter regulation control, a region display parameter of a text display region for displaying the display text in the display interface and a text display parameter of the display text in the text display region.

Based on each optional technical solution described above, optionally, the region display parameter includes at least one selected from the group consisted of a region transparency parameter, a border display color parameter, a region rotation angle regulation parameter, a region size regulation parameter, and a region display position parameter; and the text display parameter includes at least one selected from the group consisted of a font color parameter, a font type parameter, a font transparency parameter, and a font inclination angle parameter.

Based on each optional technical solution described above, optionally, the information display apparatus further includes: a display entity determination module. The display entity determination module includes: a display entity determination unit and a distinguishing display entity determination unit.

For example, the display entity determination unit is configured to configure a preset number of subtext display entities for the text display region so as to display corresponding subtexts in the subtext display entities; and the distinguishing display entity determination unit is configured to determine a distinguishing display entity from the preset number of subtext display entities, so that the first subtext matched with the display timestamp is displayed in a first form in the distinguishing display entity, and the second subtext is displayed in a second form in other subtext display entities except the distinguishing display entity.

Based on each optional technical solution described above, optionally, the display entity determination module further includes: an entity display position determination unit. The entity display position determination unit is, for example, configured to determine display positions of the preset number of subtext display entities in the text display region according to first height information of the distinguishing display entity, second height information of other subtext display entities except the distinguishing display entity, and spacing information between two adjacent subtext display entities.

Based on each optional technical solution described above, optionally, the information display apparatus further includes: a subtext display position determination module. The subtext display position determination module is configured to determine display positions of the first subtext and the second subtext in at least one subtext display entity in the text display region.

Based on each optional technical solution described above, optionally, the subtext display position determination module includes: a subtext scaling unit, a subtext offset determination unit, and a subtext display position determination unit.

For example, the subtext scaling unit is, for example, configured to: determine, for a subtext in the display text, scaling information of the subtext according to a text size of the subtext and a region size of the text display region, so as to determine a display scale of the subtext in the text display region based on the scaling information; the subtext offset determination unit is, for example, configured to determine an offset corresponding to the subtext according to the text size of the subtext, an anchor point location, and a preset text alignment; and the subtext display position determination unit is, for example, configured to determine a display position of the subtext in the subtext display entity in the text display region according to the display scale of the subtext, the anchor point location, and the offset.

Based on each optional technical solution described above, optionally, the target information display module 420 includes: a subtext distinguishing display unit. The subtext distinguishing display unit includes a target information updating sub-unit and a subtext distinguishing display sub-unit.

The target information updating sub-unit is configured to acquire a playback timestamp of the multimedia data stream at a frequency of N times per second, and update the target information by using the playback timestamp as the display timestamp; and the subtext distinguishing display sub-unit is configured to determine the first subtext according to the display timestamp in the updated target information, and display the first subtext in the first form.

Based on each optional technical solution described above, optionally, the subtext distinguishing display unit is, for example, further configured to display the first subtext corresponding to the display timestamp in the first form in the distinguishing display entity in the text display region, where the first form includes at least one selected from the group consisted of a playback animation, a display color, and a display font of the first subtext.

Based on each optional technical solution described above, optionally, the subtext distinguishing display unit is, for example, further configured to: roll, in response to the display timestamp in the target information being changed, all subtexts corresponding to a previous display timestamp in a first direction, so that at the previous display timestamp, the subtext in the distinguishing display entity is rolled into the subtext display entity which is adjacent to the distinguishing display entity and is positioned above the distinguishing display entity, and the subtext in the subtext display entity which is adjacent to the distinguishing display entity and is positioned below the distinguishing display entity is displayed in the distinguishing display entity in the first form.

Based on each optional technical solution described above, optionally, the information display apparatus further includes: a region rotation regulation module. The region rotation regulation module includes: a rotation angle determination unit and a transparency value determination unit.

For example, the rotation angle determination unit is configured to: in the process of displaying the display text, in response to detecting that a region rotation angle regulation control in a parameter regulation control is triggered, determine a regulated target region rotation angle; and the transparency value determination unit is configured to determine a transparency value corresponding to each pixel point in the text display region according to the target region rotation angle, so as to display the text display region based on the transparency value.

Based on each optional technical solution described above, optionally, the information display apparatus is applied in a scene where an effect prop is produced, or a scene where effect display is performed based on the produced effect prop.

According to the technical solutions of the embodiments of the present disclosure, when it is detected that an information display condition is satisfied, to-be-displayed target information is acquired, where the target information includes a display text and a display timestamp, the display text is associated with a multimedia data stream played by at least one second platform associated with a first platform, or the display text is associated with a multimedia data stream invoked from the first platform; and the display text is displayed in a display interface of the first platform, where the display text includes a first subtext and a second subtext, the first subtext is displayed in a different form from the second subtext in the display interface, and the first subtext is a subtext matched with the display timestamp. According to the technical solutions of the embodiments of the present disclosure, when the effect prop is produced and effect display is performed, the effect corresponding to the multimedia data stream can be displayed, so that general applicability of effect production or usage is improved.

The information display apparatus provided by the embodiment of the present disclosure may execute the information display method provided by any one of the embodiments of the present disclosure, and has functional modules and beneficial effects corresponding to the executed method.

It should be noted that each unit and module included in the apparatus are just partitioned according to functional logic, but are not limited to the partitioning results above, as long as corresponding functions can be realized. In addition, the specific name of each functional unit is also just used for facilitating mutual distinguishment, but not intended to limit the scope of protection of the embodiments of the present disclosure.

FIG. 10 is a schematic structural diagram of an electronic device provided by an embodiment of the present disclosure. Referring to FIG. 10, it shows a schematic structural diagram of an electronic device (e.g., a terminal device or a server in FIG. 10) 500 applicable to implement the embodiment of the present disclosure. The terminal device in the embodiment of the present disclosure may include, but is not limited to, a mobile terminal such as a mobile phone, a notebook computer, a digital broadcasting receiver, a Personal Digital Assistant (PDA), a PAD (tablet personal computer), a Portable Multimedia Player (PMP), a vehicle-mounted terminal (e.g., a vehicle-mounted navigation terminal) and the like, and a fixed terminal such as a digital TV, a desktop computer and the like The electronic device shown in FIG. 10 is merely one example, and should not bring any limitation to functions and the usage scope of the embodiments of the present disclosure.

As shown in FIG. 10, the electronic device 500 may include a processing device (e.g., a central processing unit, a graphics processing unit and the like) 501 which may execute various proper actions and processing according to programs stored in a Read-Only Memory (ROM) 502 or programs loaded into a Random-Access Memory (RAM) from a storage device. In the RAM 503, various programs and data required for operation of the electronic device 500 are also stored. The processing device 501, the ROM 502, and the RAM 503 are connected with each other by a bus 504. an Input/Output (I/O) interface 505 is also connected to the bus 504.

Generally, the following devices may be connected to the I/O interface 505: an input device 506 including, for example, a touch screen, a touch panel, a keyboard, a mouse, a camera, a microphone, an accelerometer, a gyroscope and the like; an output device 507 including, for example, a Liquid Crystal Display (LCD), a speaker, a vibrator and the like; a storage device 508 including, for example, a magnetic tape, a hard disk and the like; and a communication device 509. The communication device 509 may allow the electronic device 500 to have wireless or wired communication with other devices to exchange data. Although FIG. 10 shows the electronic device 500 with various devices, it should be understood that it is not required to implement or equip all the devices as shown. More or fewer devices may be alternatively implemented or equipped.

Specially, according to the embodiments of the present disclosure, the process described with reference to the flowchart in the above may be implemented as a computer software program. For example, an embodiment of the present disclosure provides a computer program product, including a computer program borne on a non-transient computer-readable medium. The computer program includes program code for executing the method shown in the flowchart. In such embodiment, the computer program may be downloaded and installed by the communication device 509, or installed from the storage device 508, or installed from the ROM 502. When the computer program is executed by the processing device 501, the above-mentioned functions defined in the method of the embodiments of the present disclosure are executed.

Names of messages or information interacted among a plurality of devices in the implementations of the present disclosure are merely used for the illustrative purpose, rather than used for limiting the scope of these messages or information.

The electronic device provided by this embodiment of the present disclosure and the information display method provided by the above-described embodiments belong to the same inventive concept, the technical details not described in detail in this embodiment of the present disclosure may refer to the above-described embodiments. This embodiment achieves the same beneficial effects with the above-described embodiments.

An embodiment of the present disclosure provides a computer storage medium having a computer program stored thereon. The computer program, when executed by a processor, implements the information display method provided by the above-described embodiments.

The computer storage medium provided by this embodiment of the present disclosure and the information display method provided by the above-described embodiments belong to the same inventive concept, the technical details not described in detail in this embodiment of the present disclosure may refer to the above-described embodiments. This embodiment achieves the same beneficial effects with the above-described embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random-access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: acquire to-be-displayed target information in response to detecting that an information display condition is satisfied, where the target information includes a display text and a display timestamp, the display text is associated with a multimedia data stream played by at least one second platform associated with a first platform, or the display text is associated with a multimedia data stream invoked from the first platform; and display the display text in a display interface of the first platform, where the display text includes a first subtext and a second subtext, the first subtext is displayed in a different form from the second subtext in the display interface, and the first subtext is a subtext matched with the display timestamp.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some case.

The functions described above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The above description merely refers to preferred embodiments of the present disclosure and the explanation of the applied technical principles. It should be understood by those skilled in the art that the disclosed scope involved in the present disclosure is not limited to the technical solutions formed by the specific combination of the above technical features, but also covers other technical solutions formed by any combination of the above technical features or their equivalent features without departing from the above disclosed concepts. For example, technical solutions formed by replacing above features with (but not limited to) technical features having similar functions disclosed in the present disclosure.

Although various operations are depicted in a specific order, it should not be construed as requiring these operations to be performed in the specific order as shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. An information display method, comprising:
acquiring, in response to detecting that an information display condition is satisfied, first information, wherein the first information comprises a display text and a display timestamp, the display text is associated with a multimedia data stream played by at least one second platform associated with a first platform, or the display text is associated with a multimedia data stream invoked from the first platform; and
displaying the display text in a display interface of the first platform, wherein the display text comprises a first subtext and a second subtext, the first subtext is displayed in a different form from the second subtext in the display interface, and the first subtext is a subtext matched with the display timestamp.

2. The method according to claim 1, further comprising:
displaying at least one parameter regulation control in the display interface, wherein the parameter regulation control is represented in a form of a progress bar; and
determining, in response to a triggering operation on the at least one parameter regulation control, a region display parameter of a text display region for displaying the display text in the display interface and a text display parameter of the display text in the text display region.

3. The method according to claim 2, wherein
the region display parameter comprises at least one selected from the group consisted of a region transparency parameter, a border display color parameter, a region rotation angle regulation parameter, a region size regulation parameter, and a region display position parameter; and
the text display parameter comprises at least one selected from the group consisted of a font color parameter, a font type parameter, a font transparency parameter, and a font inclination angle parameter.

4. The method according to claim 1, wherein before displaying the display text in the display interface of the first platform, the method further comprises:
configuring a preset number of subtext display entities for the text display region so as to display corresponding subtexts in the subtext display entities; and
determining a distinguishing display entity from the preset number of subtext display entities, so that the first subtext matched with the display timestamp is displayed in a first form in the distinguishing display entity, and the second subtext is displayed in a second form in other subtext display entities except the distinguishing display entity.

5. The method according to claim 4, wherein after determining the distinguishing display entity from the preset number of subtext display entities, the method further comprises:
determining display positions of the preset number of subtext display entities in the text display region according to first height information of the distinguishing display entity, second height information of other subtext display entities except the distinguishing display entity, and spacing information between two adjacent subtext display entities.

6. The method according to claim 1, wherein before displaying the display text in the display interface of the first platform, the method further comprises: determining display positions of the first subtext and the second subtext in at least one subtext display entity in the text display region.

7. The method according to claim 6, wherein the determining display positions of the first subtext and the second subtext in at least one subtext display entity in the text display region comprises:
determining, for each subtext in the display text, scaling information of the subtext according to a text size of the subtext and a region size of the text display region, so as to determine a display scale of the subtext in the text display region based on the scaling information;
determining an offset corresponding to the subtext according to the text size of the subtext, an anchor point location, and a preset text alignment; and
determining a display position of the subtext in the subtext display entity in the text display region according to the display scale of the subtext, the anchor point location, and the offset.

8. The method according to claim 1, wherein the displaying the display text in a display interface of the first platform comprises:
acquiring a playback timestamp of the multimedia data stream at a frequency of N times per second, and updating the first information by using the playback timestamp as the display timestamp; and
determining the first subtext according to the display timestamp in the updated first information, and displaying the first subtext in the first form.

9. The method according to claim 8, wherein the displaying the first subtext in the first form comprises:
displaying, in the distinguishing display entity in the text display region, the first subtext corresponding to the display timestamp in the first form,
wherein the first form comprises at least one selected from the group consisted of a playback animation, a display color, and a display font of the first subtext.

10. The method according to claim 9, further comprising:
rolling, in response to the display timestamp in the first information being changed, all the subtexts corresponding to a previous display timestamp in a first direction, so that the subtext displayed, at the previous display timestamp, in the distinguishing display entity is rolled into the subtext display entity which is adjacent to the distinguishing display entity and is positioned above the distinguishing display entity, and the subtext displayed, at the previous display timestamp, in the subtext display entity which is adjacent to the distinguishing display entity and is positioned below the distinguishing display entity is displayed in the distinguishing display entity in the first form.

11. The method according to claim 1, wherein the displaying the display text in a display interface of the first platform comprises:
determining, in response to detecting that a region rotation angle regulation control in a parameter regulation control is triggered, a regulated target region rotation angle; and
determining a transparency value corresponding to each pixel point in the text display region according to the target region rotation angle, so as to display the text display region based on the transparency value.

12. The method according to claim 1, wherein the multimedia data stream comprises a music being played, an audio recording being played, local audio and video being played, and/or online audio and video being played, and the method is applied in a scene where an effect prop is produced, or a scene where effect display is performed based on the produced effect prop.

13. An electronic device, comprising:
one or more processors; and
a storage device, configured to store one or more programs, wherein
the one or more programs, when executed by the one or more processors, cause the one or more processors to implement an information display method, comprising:
acquiring, in response to detecting that an information display condition is satisfied, first information, wherein the first information comprises a display text and a display timestamp, the display text is associated with a multimedia data stream played by at least one second platform associated with a first platform, or the display text is associated with a multimedia data stream invoked from the first platform; and
displaying the display text in a display interface of the first platform, wherein the display text comprises a first subtext and a second subtext, the first subtext is displayed in a different form from the second subtext in the display interface, and the first subtext is a subtext matched with the display timestamp.

14. The electronic device according to claim 13, wherein the information display method further comprises:
displaying at least one parameter regulation control in the display interface, wherein the parameter regulation control is represented in a form of a progress bar; and
determining, in response to a triggering operation on the at least one parameter regulation control, a region display parameter of a text display region for displaying the display text in the display interface and a text display parameter of the display text in the text display region.

15. The electronic device according to claim 14, wherein in the information display method,
the region display parameter comprises at least one selected from the group consisted of a region transparency parameter, a border display color parameter, a region rotation angle regulation parameter, a region size regulation parameter, and a region display position parameter; and
the text display parameter comprises at least one selected from the group consisted of a font color parameter, a font type parameter, a font transparency parameter, and a font inclination angle parameter.

16. The electronic device according to claim 13, wherein in the information display method, before displaying the display text in the display interface of the first platform, the method further comprises:
configuring a preset number of subtext display entities for the text display region so as to display corresponding subtexts in the subtext display entities; and
determining a distinguishing display entity from the preset number of subtext display entities, so that the first subtext matched with the display timestamp is displayed in a first form in the distinguishing display entity, and the second subtext is displayed in a second form in other subtext display entities except the distinguishing display entity.

17. The electronic device according to claim 16, wherein in the information display method, after determining the distinguishing display entity from the preset number of subtext display entities, the method further comprises:
determining display positions of the preset number of subtext display entities in the text display region according to first height information of the distinguishing display entity, second height information of other subtext display entities except the distinguishing display entity, and spacing information between two adjacent subtext display entities.

18. The electronic device according to claim 13, wherein in the information display method, before displaying the display text in the display interface of the first platform, the method further comprises: determining display positions of the first subtext and the second subtext in at least one subtext display entity in the text display region.

19. The electronic device according to claim 18, wherein in the information display method,
the determining display positions of the first subtext and the second subtext in at least one subtext display entity in the text display region comprises:
determining, for each subtext in the display text, scaling information of the subtext according to a text size of the subtext and a region size of the text display region, so as to determine a display scale of the subtext in the text display region based on the scaling information;
determining an offset corresponding to the subtext according to the text size of the subtext, an anchor point location, and a preset text alignment; and
determining a display position of the subtext in the subtext display entity in the text display region according to the display scale of the subtext, the anchor point location, and the offset.

20. A non-transitory computer-readable storage medium, comprising computer-executable instructions, wherein the computer-executable instructions, when executed by a computer processor, are configured to cause the computer processor to execute an information display method, comprising:
acquiring, in response to detecting that an information display condition is satisfied, first information, wherein the first information comprises a display text and a display timestamp, the display text is associated with a multimedia data stream played by at least one second platform associated with a first platform, or the display text is associated with a multimedia data stream invoked from the first platform; and
displaying the display text in a display interface of the first platform, wherein the display text comprises a first subtext and a second subtext, the first subtext is displayed in a different form from the second subtext in the display interface, and the first subtext is a subtext matched with the display timestamp.
